(19) United States
(12) Patent Application Publication
(10) Pub. No.: US 2026/0118697 A1
(43) Pub. Date: Apr. 30, 2026

(54) HINGE STRUCTURE AND SMART GLASSES

(71) Applicant: GOERTEK INC., Weifang (CN)

(72) Inventors: Chengshuo HAN, Weifang (CN); Yaocheng LIU, Weifang (CN); Chuanlong LI, Weifang (CN)

(21) Appl. No.: 19/433,492

(22) Filed: Dec. 26, 2025

Related U.S. Application Data
(63) Continuation of application No. PCT/CN2024/132033, filed on Nov. 14, 2024.

(30) Foreign Application Priority Data
Jun. 26, 2024 (CN) 202410840590.2

(51) Int. Cl. G02C 5/22; G02B 27/01

(52) U.S. Cl. CPC G02C 5/2236; G02B 27/0149; G02B 27/0176; G02B 2027/0154; G02B 2027/0178; G02C 2200/26

(57) ABSTRACT

A hinge structure and smart glasses are provided, and the hinge structure includes a first rotating member, a second rotating member, a connecting member and an elastic member. The second rotating member is provided with a limiting through hole. One end of the connecting member is rotatably provided at the first rotating member, and the other end of the connecting member is provided in the limiting through hole. The first rotating member and the connecting member are rotatable relative to each other, and the connecting member is movable linearly along the limiting through hole, so that the first rotating member and the second rotating member flip relative to each other, and a rotation axis moves linearly during the flipping. The elastic member is provided between the connecting member and the second rotating member and is configured to deform when the connecting member moves linearly to provide a restoring force.

### CROSS-REFERENCE TO RELATED APPLICATIONS

This application is a continuation application of International Application No. PCT/CN2024/132033, filed on Nov. 14, 2024, which claims priority to Chinese Patent Application No. 202410840590.2, filed on Jun. 26, 2024. The disclosures of the above-mentioned applications are incorporated herein by reference in their entireties.

### TECHNICAL FIELD

The present application relates to the technical field of smart wearable devices, and in particular to a hinge structure and smart glasses.

### BACKGROUND

As wearable products, the weight of smart glasses is a crucial parameter, directly impacting user comfort. The frame and temples of smart glasses are typically connected by a hinge structure to allow relative rotation between them. The hinge, while fulfilling its rotating shaft function, needs to be as lightweight as possible to avoid making the overall device too heavy. At the same time, due to limited space in the temples, the hinge size also needs to be as small as possible. Therefore, effectively designing a lightweight and compact hinge structure is a problem that those skilled in the art need to solve.

### SUMMARY

The purpose of the present application is to provide a hinge structure and smart glasses, the structural design of the hinge structure and smart glasses effectively solves the problems of large size and weight of conventional hinge structures.

In order to achieve the above purpose, the present application provides the following technical solution.

The present application provides a hinge structure, applied to smart glasses, including: a first rotating member, a second rotating member, a connecting member and an elastic member;
the second rotating member is provided with a limiting through hole;
one end of the connecting member is rotatably provided at the first rotating member, the other end of the connecting member is provided in the limiting through hole, the first rotating member and the connecting member are rotatable relative to each other, and the connecting member is movable linearly along the limiting through hole, so that the first rotating member and the second rotating member flip relative to each other, and a rotation axis moves linearly during the flipping; and
the elastic member is provided between the connecting member and the second rotating member and configured to deform when the connecting member moves linearly to provide a restoring force.

In an embodiment, in the above hinge structure, during a relative flipping process of the first rotating member and the second rotating member, the first rotating member is in line contact or surface contact with the second rotating member.

In an embodiment, in the above hinge structure, the first rotating member is provided with a first plane at an end facing the second rotating member, the first plane is parallel to a rotation axis of the first rotating member and the connecting member, and the second rotating member is provided with a second plane parallel to the first plane to be in surface contact with the first plane.

In an embodiment, in the above hinge structure, an outer lateral edge of the first plane is provided with an arc surface so as to make line contact with the second plane when the first rotating member and the second rotating member flip outward relative to each other.

In an embodiment, in the above hinge structure, the first rotating member is further provided with a third plane, and the first rotating member and the second rotating member are capable of flipping inward from the first plane abutting against the second plane until the third plane abuts against the second plane.

In an embodiment, in the above hinge structure, the third plane transitions to the first plane through a rounded corner, and a radius of the rounded corner is inversely related to a maximum restoring force provided by the elastic member to the second rotating member.

In an embodiment, in the above hinge structure, the connecting member includes: a connecting member body and a blocking member;
the connecting member body passes through the limiting through hole, and an end of the connecting member body is rotatably provided at the first rotating member; and
the blocking member is provided at the other end of the connecting member body, and the elastic member is provided between the blocking member and the second rotating member.

In an embodiment, in the above hinge structure, the first rotating member includes a first panel and a support provided at the first panel, and the connecting member is rotatably connected to the support; and
the first panel is provided with a position avoiding groove, the connecting member is provided in the position avoiding groove, and the first rotating member and the second rotating member are capable of flipping outward relative to each other until the connecting member abuts against an end of the position avoiding groove.

In an embodiment, in the above hinge structure, at least two connecting members are provided, and the two connecting members are provided at intervals and rotatably connected to the first rotating member through two rotating shafts; and
the hinge structure further includes an electrical connector provided in a gap between the two rotating shafts, and two ends of the electrical connector extend to the first rotating member and the second rotating member, so as to be electrically connected to electrical components in a temple and a frame of the smart glasses, respectively.

In an embodiment, in the above hinge structure, one of the first rotating member and the second rotating member is connected to the frame of the smart glasses, and the other of the first rotating member and the second rotating member is connected to the temple of the smart glasses; and
surrounding side walls of the first rotating member are flush with a side wall of a connecting end of the frame connected to the first rotating member or the temple connected to the first rotating member, and/or surrounding side walls of the second rotating member are flush with a side wall of a connecting end of the frame connected to the second rotating member or the temple connected to the second rotating member.

The hinge structure provided in the present application is applied to smart glasses and includes a first rotating member, a second rotating member, a connecting member and an elastic member. The second rotating member is provided with a limiting through hole. One end of the connecting member is rotatably provided at the first rotating member, and the other end of the connecting member is provided in the limiting through hole. The first rotating member and the connecting member can rotate relative to each other, and the connecting member can move linearly along the limiting through hole, allowing the first rotating member and second rotating member to flip relative to each other, and the rotation axis moves linearly during the flipping. The elastic member is provided between the connecting member and the second rotating member and is configured to deform when the connecting member moves linearly to provide a restoring force.

Using the hinge structure provided in the present application, one end of the connecting member is rotatably provided at the first rotating member, and the other end of the connecting member is provided in the limiting through hole and acts on the second rotating member through the elastic member. When the first rotating member and second rotating member can flip relative to each other, the first rotating member rotates relative to the connecting member, and the connecting member moves linearly along the limiting through hole relative to the second rotating member. That is, when the first rotating member and the second rotating member flip relative to each other, they rotate around the rotation axis that moves along a straight line. Therefore, the hinge structure can meet the flipping requirements with a smaller size and leave enough space for the distribution of other structural components of the smart glasses with the hinge structure, thereby reducing the overall size of the smart glasses. In addition, the weight is reduced accordingly while the size is reduced, which is conducive to its miniaturization and lightweight design.

In order to achieve the above purpose, the present application also provides smart glasses, and the smart glasses includes the hinge structure described above. Since the hinge structure described above has the above technical effects, the smart glasses having the hinge structure should also have the corresponding technical effects.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural view of a hinge structure according to an embodiment of the present application.

FIG. 2 is an exploded view of the hinge structure.

FIG. 3 is a schematic front view of the hinge structure in an open state.

FIG. 4 is a schematic front view of the hinge structure flipping outward from the open state.

FIG. 5 is a schematic front view of the hinge structure flipping inward from the open state.

FIG. 6 is a schematic front view of the hinge structure in a folded state.

FIG. 7 is a schematic structural view of a hinge structure according to another embodiment of the present application.

FIG. 8 is a schematic view of the hinge structure in FIG. 7 from another perspective.

FIG. 9 is a cross-sectional view of the hinge structure in FIG. 7 in an assembled state.

FIG. 10 is a partial schematic view of smart glasses according to an embodiment of the present application.

FIG. 11 is an exploded view of FIG. 10.

FIG. 12 is a cross-sectional view of FIG. 10.

FIG. 13 is a partial schematic view of the smart glasses with in a temple in an outward-flipping state.

FIG. 14 is a cross-sectional view of FIG. 13.

### DETAILED DESCRIPTION OF THE EMBODIMENTS

The present application discloses a hinge structure and smart glasses to reduce the space occupied by the hinge structure and reduce its weight.

The technical solutions of the embodiments of the present application will be clearly and completely described below with reference to the accompanying drawings. Obviously, the described embodiments are only some embodiments of the present application, and not all embodiments. Based on the embodiments of the present application, all other embodiments obtained by those skilled in the art without creative effort are within the scope of protection of the present application.

The hinge structure provided in the present application can be used for rotational connection between two connecting members, and its specific application is not limited to the connection between the temple and frame of smart glasses. In a conventional hinge structure, the rotation axis is fixed relative to the hinge structure during rotation. The present application provides a hinge structure, and the first rotating member and the second rotating member of the hinge structure can rotate relative to each other to achieve rotational connection between two connecting members respectively connected to the first rotating member and the second rotating member. When the first rotating member and the second rotating member rotate relative to each other, they no longer use a fixed rotation axis as the rotation center. That is, the rotation axis can move linearly when the first rotating member and the second rotating member rotate relative to each other.

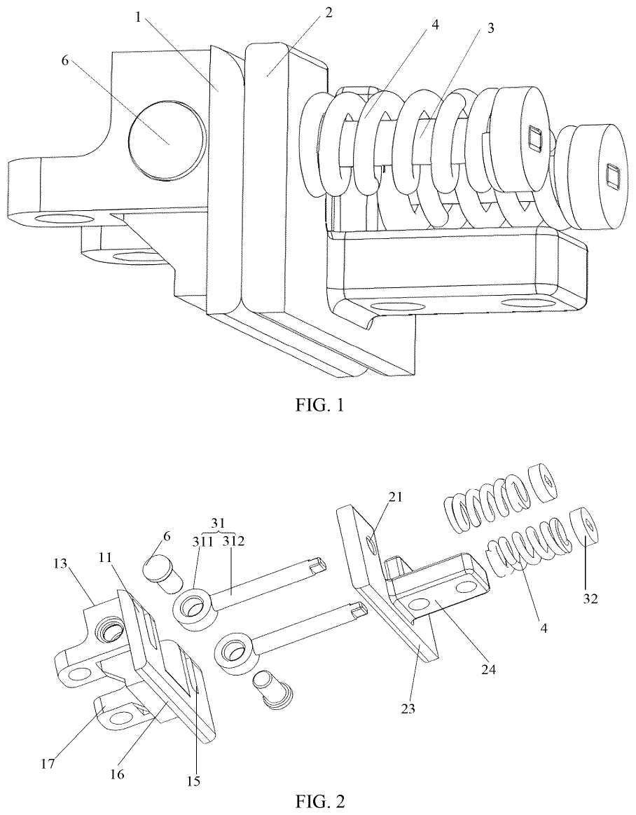

In some embodiments, referring to FIG. 1 to FIG. 2, the hinge structure provided in the present application includes a first rotating member 1, a second rotating member 2, a connecting member 3 and an elastic member 4. The first rotating member 1 and the second rotating member 2 are two main body structures of the hinge structure that rotate relative to each other. One of the first rotating member 1 and the second rotating member 2 can be connected to the temple of the smart glasses, and the other of the first rotating member 1 and the second rotating member 2 is connected to the frame of the smart glasses. The temple can be folded or opened relative to the frame through the relative rotation of the first rotating member 1 and the second rotating member 2. The second rotating member 2 is provided with a limiting through hole 21. One end of the connecting member 3 is rotatably provided at the first rotating member 1, and the other end of the connecting member 3 is provided in the limiting through hole 21. Specifically, one end of the connecting member 3 is rotatably connected to the first rotating member, and the other end of the connecting member 3 is slidably connected to the second rotating member. The first rotating member 1 and the connecting member 3 can rotate relative to each other, and the connecting member 3 can move linearly along the limiting through hole 21, so that the first rotating member 1 and the second rotating member 2 can flip relative to each other, and the rotation axis during the flipping moves linearly. That is, the first rotating member 1 and the second rotating member 2 no longer use a fixed rotation axis as the center of rotation when flipping. Specifically, the first rotating member 1 and the second rotating member 2 can rotate relative to each other around the rotation axis of the linearly moving first rotating member 1 and the connecting member 3. The elastic member 4 is provided between the connecting member 3 and the second rotating member 2. When the first rotating member 1 and the second rotating member 2 flip relative to each other, the connecting member 3 moves linearly accordingly, so that the connecting member 3 acts on the elastic member 4 to cause it to elastically deform and provide a restoring force. Since the elastic member 4 is provided between the connecting member 3 and the second rotating member 2, the force of the elastic member 4 also acts on the second rotating member 2, so that the second rotating member 2 can abut against the first rotating member 1. In this embodiment, the connecting member 3 and the elastic member 4 cooperate with the first rotating member 1 and the second rotating member 2, and the limiting through hole 21 is configured to restrict the degree of freedom of the connecting member 3, allowing the connecting member 3 to move only in a straight line along the limiting through hole 21. That is, when the first rotating member 1 and the second rotating member 2 flip relative to each other, the connecting member 3 can only move in a straight line along the limiting through hole 21, thereby ensuring that the connecting member 3 has a definite displacement trajectory. In addition, the connecting member 3 cooperates with the elastic member 4 to ensure that the first rotating member 1 and the second rotating member 2 will not move up and down in the direction perpendicular to the limiting through hole 21, thus ensuring that the hinge structure as a whole has a unique and definite motion trajectory.

Using the hinge structure provided in the present application, one end of the connecting member 3 is rotatably provided at the first rotating member 1, and the other end of the connecting member 3 is provided in the limiting through hole 21 and acts on the second rotating member 2 through the elastic member 4. When the first rotating member 1 and the second rotating member 2 flip relative to each other, the first rotating member 1 rotates relative to the connecting member 3, and at the same time, the connecting member 3 moves linearly along the limiting through hole 21 relative to the second rotating member 2. That is, when the first rotating member 1 and the second rotating member 2 flip relative to each other, they rotate around the axis of linear movement. Therefore, the hinge structure can meet the flipping requirements with a smaller size and leave enough space for the distribution of other structural components of the smart glasses with the hinge structure, thereby reducing the overall size of the smart glasses. In addition, the weight is reduced accordingly while the size is reduced, which is conducive to its miniaturization and lightweight design.

In some embodiments, the hinge structure has zero visible gaps when flipping. Since the rotation center is not fixed during flipping, the first rotating member 1 and the second rotating member 2 form a line-to-surface or surface-to-surface fit, meaning the first rotating member 1 and the second rotating member 2 always remain in contact, achieving the goal of zero visible gaps. In an embodiment, referring to FIG. 1 to FIG. 6, during the relative flipping process of the first rotating member 1 and the second rotating member 2, the first rotating member 1 and the second rotating member 2 are in line contact or surface contact. It can be understood that since the rotation axes of the first rotating member 1 and the second rotating member 2 can always maintain linear movement during the flipping process, therefore, based on the structure of the first rotating member 1 and the second rotating member 2, they can always maintain line contact during relative flipping, or surface contact at certain angles and line contact at other angles. From the appearance, the first rotating member 1 and the second rotating member 2 always remain in a close fit. Thus, when the hinge structure is connected to the temple and the frame, the temple and the frame always remain in a close fit, ensuring that the two fit tightly at any rotation angle. This significantly improves the aesthetic appearance of the overall structure, eliminating the need to provide a blocking component for blocking the hinge structure, thus simplifying the structure.

In some embodiments, referring to FIG. 1 to FIG. 6, the first rotating member 1 is provided with a first plane 11 at one end facing the second rotating member 2, the first plane 11 is parallel to the rotation axis of the first rotating member 1 and the connecting member 3, and the second rotating member 2 is provided with a second plane 22 parallel to the first plane 11 for surface contact with the first plane 11. By providing the first plane 11 and the second plane 22, the first rotating member 1 and the second rotating member 2 can flip to surface contact, that is, the first plane 11 is in contact with the second plane 22, and the elastic member 4 can provide a force to the second rotating member 2, so that the hinge structure can be stably maintained in the current state to meet the normal use of the hinge structure. In an embodiment, when the first rotating member 1 and the second rotating member 2 are connected to the temple and the frame respectively, the temple is open when the first plane 11 is in contact with the second plane 22.

In some embodiments, as shown in FIG. 1 to FIG. 4, the outer lateral edge of the first plane 11 is provided with an arc surface 12 to make line contact with the second plane 22 when the first rotating member 1 and the second rotating member 2 flip outward relative to each other. It should be noted that the outer lateral here refers to the direction in which the first rotating member 1 and the second rotating member 2 flip to one side from the state where the first plane 11 is in contact with the second plane 22, and the corresponding inner lateral is the direction in which they flip to the other side. When the hinge structure is connected to the temple and the frame, the outer lateral refers to the temple flipping outward relative to the frame, and the inner lateral refers to the temple flipping inward relative to the frame. By providing the arc surface 12 at the outer lateral edge of the first plane 11, the arc surface 12 can make line contact with the second plane 22 when the first rotating member 1 and the second rotating member 2 flip outward relative to each other, thus avoiding gaps between the first rotating member 1 and the second rotating member 2 during flipping. On the other hand, the arc surface 12 makes operation easier when the user flips the first rotating member 1 or the second rotating member 2, and the friction generated by the transition of the arc surface 12 when the first rotating member 1 and the second rotating member 2 flip relative to each other is rolling friction, which is less than the frictional force of sliding friction, and therefore less prone to wear. In other embodiments, the arc surface 12 may not be provided, that is, the edge of the first plane 11 may be a straight edge, which can also maintain line contact with the second plane 22.

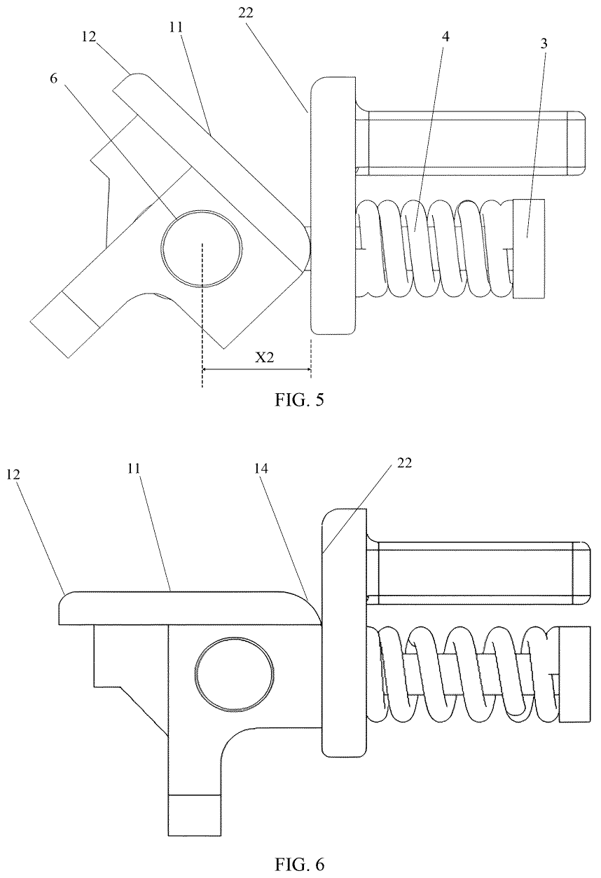

In some embodiments, referring to FIG. 5 to FIG. 6, the first rotating member 1 is further provided with a third plane 13, and the first rotating member 1 and the second rotating member 2 can flip inward from the point where the first plane 11 abuts against the second plane 22 until the third plane 13 abuts against the second plane 22. By providing the third plane 13, the first rotating member 1 and the second rotating member 2 can flip to surface contact. That is, the third plane 13 is in contact with the second plane 22, and the elastic member 4 can provide a force to the second rotating member 2, so that the hinge structure can be stably maintained in a current state to meet another conventional use state of the hinge structure. That is, in the hinge structure of this embodiment, the first rotating member 1 and the second rotating member 2 can be kept in contact with the first plane 11 and the second plane 22 under the action of the elastic member 4. When it is necessary to flip, an external force is applied to the first rotating member 1 and/or the second rotating member 2 to make them flip inward relative to each other. When the first rotating member 1 and the second rotating member 2 flip to the point where the third plane 13 is in contact with the second plane 22, they can be maintained in a current state under the action of the elastic member 4. During the rotation from a state where the first plane 11 is in contact with the second plane 22 to a state where the third plane 13 is in contact with the second plane 22, the first rotating member 1 can always maintain line contact with the second plane 22. In an embodiment, when the first rotating member 1 and the second rotating member 2 are connected to the temple and the frame respectively, the temple is folded relative to the frame when the third plane 13 is in contact with the second plane 22. The angle between the first plane 11 and the third plane 13 can be provided as needed; for example, it can be perpendicular or, depending on the usage scenario, it can be at other angles such as 60 degrees or 100 degrees.

In some embodiments, referring to FIG. 5 to FIG. 6, the third plane 13 transitions to the first plane 11 by an arc surface. By providing an arc surface between the third plane 13 and the first plane 11, on the one hand, when the first rotating member 1 and the second rotating member 2 flip inward relative to each other, the arc surface can make line contact with the second plane 22, avoiding the gap between the first rotating member 1 and the second rotating member 2 during flipping. On the other hand, the arc surface makes operation easier for the user when flipping the first rotating member 1 or the second rotating member 2, and the rolling friction generated when the first rotating member 1 and the second rotating member 2 flip relative to each other, which is less than the frictional force of sliding friction, and therefore less prone to wear. In other embodiments, the arc surface may not be provided; that is, the area between the first plane 11 and the third plane 13 can also a straight edge, which can still maintain line contact with the second plane 22.

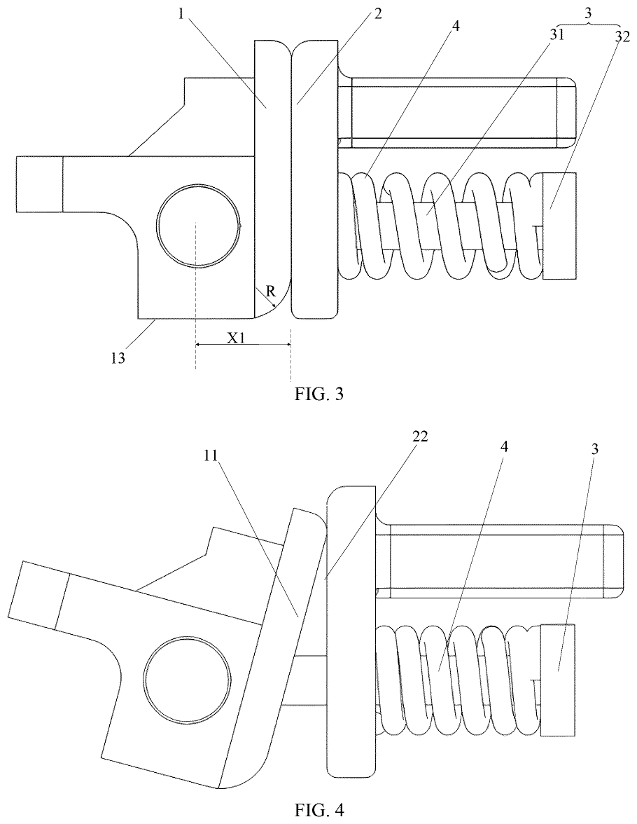

In some embodiments, as shown in FIG. 3 and FIG. 5 to FIG. 6, the third plane 13 transitions to the first plane 11 by a rounded corner 14, and the radius R of the rounded corner 14 is inversely related to the maximum restoring force provided by the elastic member 4 to the second rotating member 2. By providing the rounded corner 14, when the first rotating member 1 and the second rotating member 2 flip inward from the state where the first plane 11 is in contact with the second plane 22, the elastic member 4 deforms, and the amount of deformation of the elastic member 4 is inversely related to the radius R of the rounded corner 14. That is, the larger the radius R of the rounded corner 14, the smaller the maximum deformation of the elastic member 4; conversely, the smaller the radius R of the rounded corner 14, the larger the maximum deformation of the elastic member 4. As shown in FIG. 3, when the first plane 11 is in contact with the second plane 22, the distance between the rotation axis of the first rotating member 1 and the connecting member 3 and the second plane 22 is X1. As shown in FIG. 5, during the inward flipping process, the maximum distance between the rotation axis of the first rotating member 1 and the connecting member 3 and the second plane 22 is X2, then ΔX=X2−X1, and ΔX is the amount of deformation of the elastic member 4. The maximum restoring force provided by the elastic member 4 to the second rotating member 2 is determined by ΔX. Therefore, by providing the radius R of the rounded corner 14, the maximum restoring force provided by the elastic member 4 to the second rotating member 2 when flipping inward can be adjusted. The slingshot effect force value of the hinge structure can be adjusted by changing the radius R. The adjustment is convenient and does not require replacing the elastic member 4 or disassembling and modifying the entire hinge structure.

In the above embodiments, the scenarios where the first rotating member 1 and the second rotating member 2 flip inward and outward relative to each other are described respectively. When the first rotating member 1 and the second rotating member 2 flip inward and outward from the state where the first plane 11 is in contact with the second plane 22, the connecting member 3 can act on the elastic member 4 to deform it. Therefore, the restoring force of the elastic member 4 can act on the second rotating member 2, which is the force that enables the second rotating member 2 to automatically reset when the hinge structure connects the temple to the frame, it can provide an automatic reset force for the temple. When the temple flips outward, it can provide a clamping force for the temple, ensuring a reliable fit to the head of the user.

Depending on actual needs, the flipping of the first rotating member 1 and the second rotating member 2 in the above embodiments may only include outward flipping, that is, flipping outward from the state where the first plane 11 is in contact with the second plane 22; or it may only include inward flipping, that is, flipping inward from the state where the first plane 11 is in contact with the second plane 22; or it may include both inward flipping and outward flipping. In the state where the first plane 11 and the second plane 22 are not provided, inward flipping and outward flipping correspond to forward flipping and reverse flipping, respectively.

In some embodiments, referring to FIG. 1 to FIG. 6, the connecting member 3 includes a connecting member body 31 and a blocking member 32. The connecting member body 31 is provided in the limiting through hole 21, and one end of the connecting member body 31 is rotatably provided at the first rotating member 1. The blocking member 32 is provided at the other end of the connecting member body 31, and the elastic member 4 is provided between the blocking member 32 and the second rotating member 2. It can be understood that the blocking member 32 and the connecting member body 31 can be an integral structure or a separate structure connected by a conventional fixing method. The blocking member 32 is opposite to the second rotating member 2 to facilitate the installation of the elastic member 4, such that the two ends of the elastic member 4 abut against the second rotating member 2 and the blocking member 32 respectively. When the first rotating member 1 and the second rotating member 2 flip relative to each other, the connecting member body 31 moves along the limiting through hole 21, and the blocking member 32 acts on the elastic member 4 accordingly to compress or release it.

In some embodiments, the elastic member 4 includes a helical spring, and the helical spring can be sleeved on the outside of the connecting member body 31. Thus the connecting member body 31 can support and guide the helical spring, making its deformation more stable. In other embodiments, the elastic member 4 can also be other elastic material members or elastic structural members capable of providing restoring force.

In some embodiments, the connection between the connecting member 3 and the first rotating member 1 is achieved through a rotating shaft 6. The rotating shaft 6 is provided in both the through hole on the first rotating member 1 and the through hole on the connecting member 3, so that the connecting member 3 can rotate around the rotating shaft 6 while connecting the connecting member 3 to the first rotating member 1. The connection between the connecting member 3 and the second rotating member 2 is achieved through an elastic member 4 and a blocking member 32. The connecting member 3 passes through the limiting through hole 21 of the second rotating member 2 and the helical spring, and is then fixed to the blocking member 32. The two ends of the elastic member 4 abut against the second rotating member 2 and the blocking member 32. The blocking member 32 and the elastic member 4 ensure that the connecting member 3 is provided in the limiting through hole 21 and cannot be dislodged. The connecting member 3 is limited by the through hole to only reciprocate horizontally. The elastic member 4 maintains a certain preload, which ensures that the first rotating member 1 are always tightly connected to the second rotating member 2.

In some embodiments, the first rotating member 1 includes a first panel 16 and a support 17 provided at the first panel 16. The connecting member 3 is rotatably connected to the support 17. The first panel 16 is provided with a position avoiding groove 15. The connecting member 3 is provided in the position avoiding groove 15. It can be understood that the first panel 16 and the support 17 can be an integral structure or a separate structure connected by a conventional fixing method. The support 17 is rotatably connected to the connecting member 3. When the connecting member 3 includes a connecting member body 31 and a blocking member 32, one end of the connecting member body 31 is rotatably connected to the support 17. The position avoiding groove 15 can specifically be strip-shaped, one end of the position avoiding groove 15 extends to the edge of the first panel 16, i.e., forming an open, to facilitate the assembly of the connecting member 3. When the first rotating member 1 and the second rotating member 2 flip relative to each other, the connecting member 3 moves linearly along the limiting through hole 21, and the connecting member 3 rotates relative to the support 17 around the rotation axis. Then the connecting member 3 can move within the position avoiding groove 15, avoiding motion interference.

In an embodiment, the first rotating member 1 and the second rotating member 2 can flip outward relative to each other until they abut against one end of the connecting member 3 and the position avoiding groove 15. That is, the cooperation between the position avoiding groove 15 and the connecting member 3 achieves the limitation of the outward flipping angle of the first rotating member 1 and the second rotating member 2, preventing the outward flipping angle from being too large. In an embodiment, the limit angle of the outward flipping of the first rotating member 1 and the second rotating member 2 is set to 20 degrees to 30 degrees.

In other embodiments, the outward turning angle of the first rotating member 1 and the second rotating member 2 can also be limited by providing a limiting structure at the second rotating member 2 that cooperates with the connecting member 3. When the connecting member 3 includes a connecting member body 31 and a blocking member 32, a limiting member is provided at the second rotating member 2 opposite to the blocking member 32. When the first rotating member 1 and the second rotating member 2 flip outward relative to each other, the blocking member 32 moves linearly close to the limiting member until the blocking member 32 abuts against the limiting member, thereby limiting the further outward flipping of the first rotating member 1 and the second rotating member 2, that is, reaching the outward flipping limit angle.

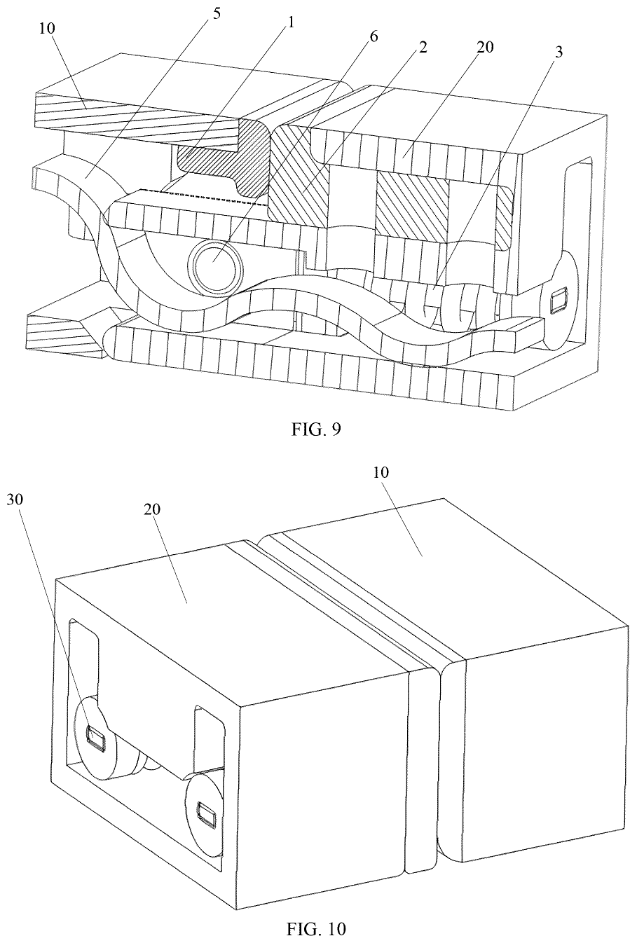

In some embodiments, as shown in FIG. 2 or FIG. 7 to FIG. 9, the hinge structure includes at least two connecting members 3, and the two connecting members 3 are provided at intervals and rotatably connected to the first rotating member 1 through two rotating shafts 6. By providing two connecting members 3 to cooperate with the first rotating member 1 and the second rotating member 2, the flipping cooperation between the two is made more stable and reliable. Furthermore, the two connecting members 3 are respectively connected to the first rotating member 1 through separate rotating shafts 6, which eliminate the need for a long rotating shaft and reducing the overall weight. In an embodiment, one of the two rotating shafts 6 is rotatably connected to the outer end of the first connecting member 3 away from the second connecting member 3, and another of the two rotating shafts 6 is rotatably connected to the outer end of the second connecting member 3 away from the first connecting member 3.

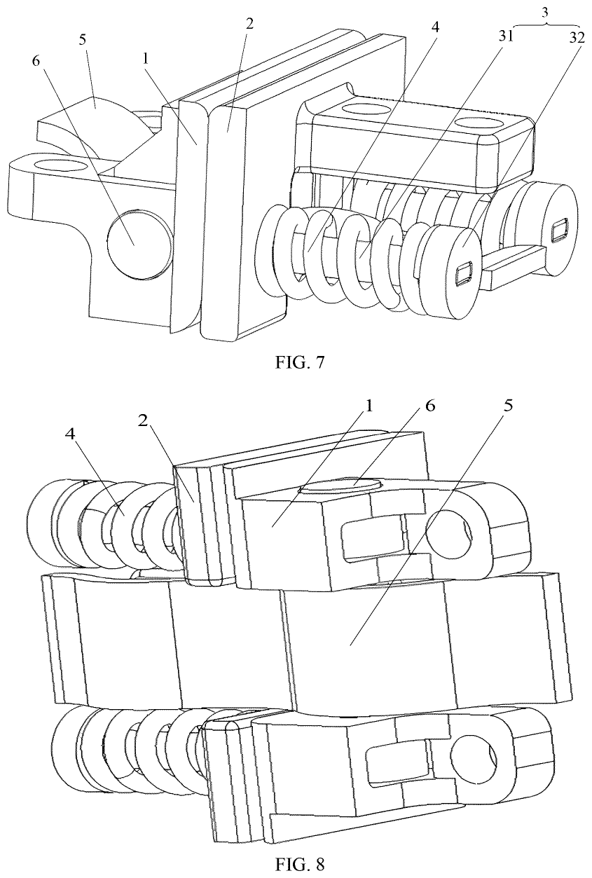

In some embodiments, referring to FIG. 7 to FIG. 9, the hinge structure includes an electrical connector 5, and the electrical connector 5 is provided in the gap between two rotating shafts 6, and two ends of the electrical connector extend to the first rotating member 1 and the second rotating member 2, respectively, to be electrically connected to the electrical components in the temple and frames of the smart glasses. By providing the electrical connector 5, the electrical components in the frame and temple are electrically connected, thereby realizing corresponding power supply and/or communication functions. It can be understood that the electrical components include, but are not limited to, a flexible circuit board, a rigid circuit board, a spring, a pin, etc. The electrical connector 5 can specifically be a flexible circuit board, a wire, etc. The two rotating shafts 6 and the two connecting members 3 are provided at intervals, thus providing a wire passage space for the electrical connector 5. A shaftless design can be adopted in the wire passage space, that is, no physical rotating shaft is provide in the wire passage space. The electrical connector 5 can directly pass through the rotation axes of the first rotating member 1 and the connecting member 3. Therefore, when the hinge structure flips, the length change of the electrical connector 5 during the corresponding bending process is minimal, which greatly improves the life of the electrical connector 5. On the other hand, this structure allows the electrical connector 5 to be inserted after the hinge structure has been mounted, making assembly simple, unaffected by the size of the electrical connector 5 joint, and requiring low assembly precision.

In some embodiments, referring to FIG. 10, one of the first rotating member 1 and the second rotating member 2 is configured to be connected to the frame of the smart glasses, and the other the first rotating member 1 and the second rotating member 2 is configured to be connected to the temple of the smart glasses. The surrounding side walls of the first rotating member 1 are flush with the side walls of the connecting end of the frame or temple connected thereto, and/or the surrounding side walls of the second rotating member 2 are flush with the side walls of the connecting end of the frame or temple connected thereto. That is, after the first rotating member 1 is assembled with the corresponding connecting end, the surroundings of the first rotating member 1 are flush with the surroundings of the corresponding connecting end. Correspondingly, after the second rotating member 2 is assembled with the corresponding connecting end, the surroundings of the second rotating member 2 are flush with the surroundings of the corresponding connecting end. The end faces of the first rotating member 1 and the second rotating member 2 serve as moving contact surfaces and also as the appearance surfaces of the hinge structure. On the one hand, this prevents the hinge structure from being embedded in the corresponding connecting end (such as the plastic shell), reducing the precision requirements, avoiding step differences in appearance, and ensuring the integrity and aesthetics of the appearance. On the other hand, the end surface of the hinge structure is set as the appearance surface, specifically the first plane 11 and the second plane 22 as the appearance surface, which provides a larger contact area, reduces wear, and extends the service life of the hinge structure.

In some embodiments, referring to FIG. 2, the first rotating member 1 includes a first panel 16 and a support 17, and the first panel 16 is configured to cooperate with the second rotating member 2. The first panel 16 is provided with a position avoiding groove 15, and the connecting member body 31 is provided in the position avoiding groove 15. The support 17 is provided with a through hole. The connecting member body 31 specifically includes a connecting rod 312 and a connecting ring 311 provided at the end of the connecting rod 312, the hollow part of the connecting ring 311 is opposite to the through hole, and the rotating shaft 6 is provided in the through hole and the connecting ring 311 to rotatably connect the connecting member body 31 and the support 17. When the first rotating member 1 is provided with at least one of the above first plane 11, the third plane 13, the arc surface 12 and the rounded corner 14, they are all provided at the first panel 16. When the first rotating member 1 is assembled on the temple or the frame, the surrounding side walls of the first panel 16 are flush with the surrounding side walls of the connecting end on the corresponding temple or frame. The support 17 may specifically be provided with a first fixing portion, such as a screw hole, to be connected with the corresponding connecting end screw. The first fixing portion is specifically located on the portion of the support 17 perpendicular to the first panel 16, so as to make fuller use of space and reduce the space occupied by the hinge structure. In summary, the first rotating member 1 adopts the above arrangement, which has a simple and compact structure, facilitates cooperation and connection with various components, ensures reliable overall structural connection, stable movement, and small space occupation.

In some embodiments, referring to FIG. 2, the second rotating member 2 includes a second panel 23 and a lug 24, and the second panel 23 is configured to cooperate with the first rotating member 1. A limiting through hole 21 is provided at the second panel 23, and the lug 24 is provided at the second panel 23. When the second rotating member 2 is provided with the above second plane 22, the second rotating member 2 is provided at the second panel 23. When the second rotating member 2 is assembled to the temple or frame, the surrounding side walls of the second panel 23 are flush with the surrounding side walls of the connecting end on the corresponding temple or frame. The lug 24 is provided with a second fixing portion, such as a screw hole, for screw connection with the corresponding connecting end. The lug 24 is specifically perpendicular to the second panel 23 to make fuller use of space, thereby reducing the space occupied by the hinge structure.

Based on the hinge structure provided in the above embodiments, the present application also provides smart glasses, and the smart glasses include any of the hinge structures described in the above embodiments. Since the smart glasses employ the hinge structure described in the above embodiments, the beneficial effects of the smart glasses can be found in the above embodiments.

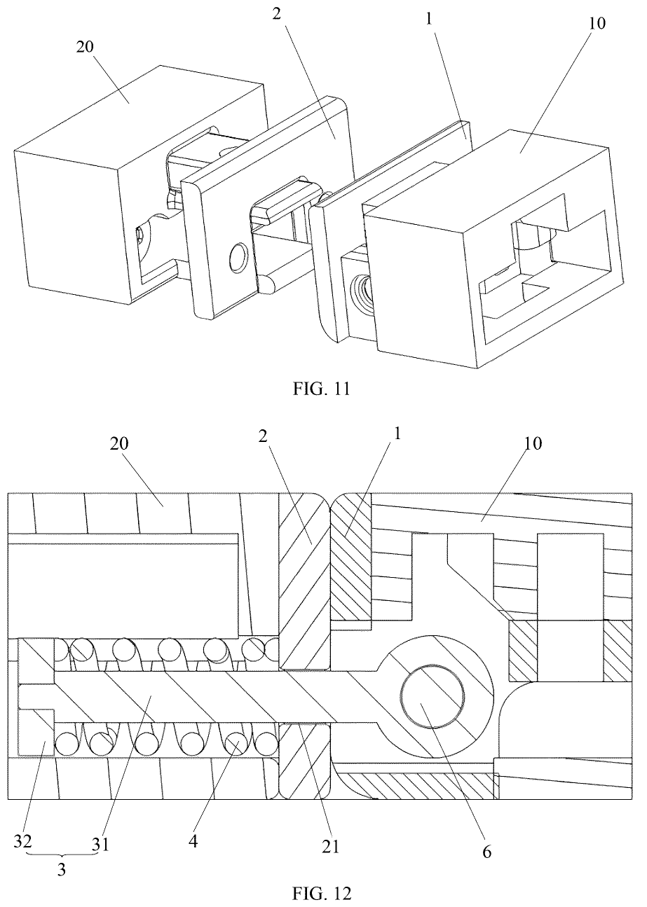

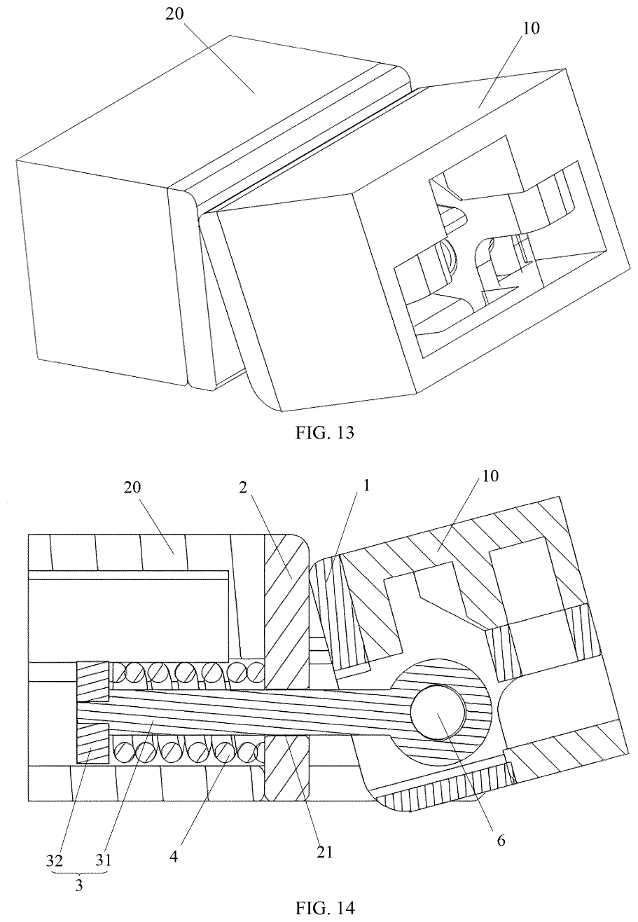

In some embodiments, referring to FIG. 10 to FIG. 14, the smart glasses includes a frame 10, a temple 20 and a hinge structure 30. One of the first rotating member 1 and the second rotating member 2 of the hinge structure 30 is connected to the frame, and the other of the first rotating member 1 and the second rotating member 2 of the hinge structure 30 is connected to the temple. The electrical component on the frame and the electrical component on the temple are respectively electrically connected to the electrical connector 5. The hinge structure not only meets the rotational connection requirements of the frame and temple, but also enables reliable electrical connection between the electrical component on the frame and the electrical component on the temple.

The various embodiments in this specification are described in a progressive manner, with each embodiment focusing on the differences from other embodiments. The same or similar parts between the various embodiments can be referred to each other.

The above description of the disclosed embodiments enables those skilled in the art to make or use the present application. Various modifications to these embodiments will be readily apparent to those skilled in the art, and the general principles defined herein may be implemented in other embodiments without departing from the spirit or scope of the present application. Therefore, the present application is not to be limited to the embodiments shown herein, but is to be accorded the widest scope consistent with the principles and novel features disclosed herein.

Although the embodiments of the present application have been described, those skilled in the art, upon learning the basic inventive concept, can make other changes and modifications to the embodiments. Therefore, the appended claims are intended to be interpreted as including the embodiments as well as all changes and modifications falling within the scope of the present application.

The above description is merely some embodiments of the present application and does not limit the scope of the present application. Any equivalent structural transformations made based on the content of the present application's specification and drawings under the concept of the present application, or direct/indirect applications in other related technical fields, are included within the scope of the present application.

What is claimed is:

1. A hinge structure, applied to smart glasses, comprising:
a first rotating member;
a second rotating member provided with a limiting through hole;
a connecting member, wherein one end of the connecting member is rotatably provided at the first rotating member, the other end of the connecting member is provided in the limiting through hole, the first rotating member and the connecting member are rotatable relative to each other, and the connecting member is movable linearly along the limiting through hole, so that the first rotating member and the second rotating member flip relative to each other, and a rotation axis moves linearly during the flipping; and
an elastic member provided between the connecting member and the second rotating member and configured to deform when the connecting member moves linearly to provide a restoring force.

2. The hinge structure according to claim 1, wherein during a relative flipping process of the first rotating member and the second rotating member, the first rotating member is in line contact or surface contact with the second rotating member.

3. The hinge structure according to claim 2, wherein the first rotating member is provided with a first plane at an end facing the second rotating member, the first plane is parallel to a rotation axis of the first rotating member and the connecting member, and the second rotating member is provided with a second plane parallel to the first plane to be in surface contact with the first plane.

4. The hinge structure according to claim 3, wherein an outer lateral edge of the first plane is provided with an arc surface so as to make line contact with the second plane when the first rotating member and the second rotating member flip outward relative to each other.

5. The hinge structure according to claim 3, wherein the first rotating member is further provided with a third plane, and the first rotating member and the second rotating member are capable of flipping inward from the first plane abutting against the second plane until the third plane abuts against the second plane.

6. The hinge structure according to claim 5, wherein the third plane transitions to the first plane through a rounded corner, and a radius of the rounded corner is inversely related to a maximum restoring force provided by the elastic member to the second rotating member.

7. The hinge structure according to claim 1, wherein the connecting member comprises:
a connecting member body passing through the limiting through hole, wherein an end of the connecting member body is rotatably provided at the first rotating member; and
a blocking member provided at the other end of the connecting member body, wherein the elastic member is provided between the blocking member and the second rotating member.

8. The hinge structure according to claim 1, wherein:
the first rotating member comprises a first panel and a support provided at the first panel, and the connecting member is rotatably connected to the support; and
the first panel is provided with a position avoiding groove, the connecting member is provided in the position avoiding groove, and the first rotating member and the second rotating member are capable of flipping outward relative to each other until the connecting member abuts against an end of the position avoiding groove.

9. The hinge structure according to claim 1, wherein:
at least two connecting members are provided, and the two connecting members are provided at intervals and rotatably connected to the first rotating member through two rotating shafts; and
the hinge structure further comprises an electrical connector provided in a gap between the two rotating shafts, and two ends of the electrical connector extend to the first rotating member and the second rotating member, so as to be electrically connected to electrical components in a temple and a frame of the smart glasses, respectively.

10. The hinge structure according to claim 1, wherein:
one of the first rotating member and the second rotating member is connected to the frame of the smart glasses, and the other of the first rotating member and the second rotating member is connected to the temple of the smart glasses; and
surrounding side walls of the first rotating member are flush with a side wall of a connecting end of the frame connected to the first rotating member or the temple connected to the first rotating member, and/or surrounding side walls of the second rotating member are flush with a side wall of a connecting end of the frame connected to the second rotating member or the temple connected to the second rotating member.

11. Smart glasses, comprising:
a frame;
a temple, and
the hinge structure according to claim 1,
wherein one of the first rotating member and the second rotating member is connected to the frame, and the other of the first rotating member and the second rotating member is connected to the temple.
